(19) United States
(12) Patent Application Publication
(10) Pub. No.: US 2024/0428445 A1
(43) Pub. Date: Dec. 26, 2024

(54) IMAGE PROCESSING APPARATUS, CONTROL METHOD THEREFOR, STORAGE MEDIUM, SYSTEM, AND LEARNED DATA GENERATION METHOD

(71) Applicant: CANON KABUSHIKI KAISHA, Tokyo (JP)

(72) Inventors: KENTA TACHIKAWA, Tokyo (JP); AKIRA KOSUGE, Tokyo (JP)

(21) Appl. No.: 18/824,063

(22) Filed: Sep. 4, 2024

Related U.S. Application Data
(63) Continuation of application No. PCT/JP2022/048566, filed on Dec. 28, 2022.

(30) Foreign Application Priority Data
Mar. 22, 2022 (JP) 2022-046036
Sep. 5, 2022 (JP) 2022-141014

(51) Int. Cl. G06T 7/73; G06T 3/40; G06T 5/60; G06T 5/70; G06T 5/73; G06T 7/246; G06T 7/90

(52) U.S. Cl. CPC G06T 7/73; G06T 3/40; G06T 5/60; G06T 5/70; G06T 5/73; G06T 7/246; G06T 7/90; G06T 2207/10016; G06T 2207/20081; G06T 2207/20084; G06T 2207/30221

(57) ABSTRACT

There is provided an image processing apparatus that detects a predetermined object in a video. A reducing generates a reduced image of a pre-set size from an image of a frame included in the video. A generating unit generates a motion component enhanced image based on a current reduced image expressing a current frame obtained by the reducing unit, a first reduced image from a predetermined length of time before the current reduced image, and a second reduced image from a predetermined length of time before the first reduced image. A determining unit determines a position of an object using the motion component enhanced image obtained by the generating unit.

### CROSS-REFERENCE TO RELATED APPLICATIONS

This application is a Continuation of International Patent Application No. PCT/JP2022/048566, filed Dec. 28, 2022, which claims the benefit of Japanese Patent Application No. 2022-046036, filed Mar. 22, 2022, and Japanese Patent Application No. 2022-141014, filed Sep. 5, 2022, all of which are hereby incorporated by reference herein in their entirety.

### BACKGROUND OF THE INVENTION

### Field of the Invention

The present invention relates to an image processing apparatus, a control method therefor, a storage medium, a system, and a learned data generation method.

### Background Art

Recently, as a method for automatically generating a moving image of a sports game for broadcast, shot data is obtained at an angle of view that covers the entire court where the game is played, and part of the data is then cropped out at an angle of view where part of the court appears. Specifically, in a moving image of a basketball game, the positions of the players and the ball are obtained, and the angle of view at which the image is to be cropped out is determined so as to include the players and the ball. In particular, when the image is cropped out at an angle of view covering approximately half the court to enable viewers to follow the progress of the basketball game, it is necessary to ensure that the ball falls within the angle of view.

When recognizing a player or a ball, the shot data is typically subjected to reduction processing before the recognition processing in order to reduce the processing load and enable the image processing to be performed in real time. However, when shot data at an angle of view covering the entire court is subjected to reduction processing, the resolution of the basketball appearing therein drops, and spatial features such as the pattern and shape of the ball are lost. At this time, performing the recognition processing at a lower reduction ratio is expected to make it possible to suppress the spatial feature loss and recognize the basketball. However, this results in the recognition processing taking a long time, and is therefore not be suitable for real-time processing. Accordingly, a system that performs recognition processing based on motion components in a video by referring to past and current shot data has been proposed as a method that supplements such spatial features (for example, Japanese Patent Laid-Open No. 5-339724).

Japanese Patent Laid-Open No. 5-339724 discloses a technique for recognizing a moving object in a current frame based on the current frame and two past frames in the shot data. In basketball, the ball is rarely stationary, and this technique makes it possible to recognize the ball in the video.

However, with the past technique disclosed in Japanese Patent Laid-Open No. 5-339724, stationary objects cannot be detected during a sports game. Specifically, even during a basketball game, when a player takes a free throw, players other than the player taking the shot, referees, and the like may be stationary, and those players therefore cannot be recognized. The past technique therefore still has a problem in that player information for cropping out an appropriate range from shot data including the entire court is missing.

### SUMMARY OF THE INVENTION

Having been achieved in light of the foregoing problem, the present invention provides a technique for detecting an object in a video, regardless of the size, motion, and the like thereof, at high speed and with high accuracy.

According to a first aspect of the present invention, there is provided an image processing apparatus that detects a predetermined object in a video, the image processing apparatus comprising: a reducing unit configured to generate a reduced image of a pre-set size from an image of a frame included in the video; a generating unit configured to generate a motion component enhanced image based on a current reduced image expressing a current frame obtained by the reducing unit, a first reduced image from a predetermined length of time before the current reduced image, and a second reduced image from a predetermined length of time before the first reduced image; and a determining unit configured to determine a position of an object using the motion component enhanced image obtained by the generating unit.

According to a second aspect of the present invention, there is provided a control method for an image processing apparatus that detects a predetermined object in a video, the control method comprising: generating a reduced image of a pre-set size from an image of a frame included in the video; generating a motion component enhanced image based on a current reduced image expressing a current frame obtained by the generating a reduced image, a first reduced image from a predetermined length of time before the current reduced image, and a second reduced image from a predetermined length of time before the first reduced image; and determining a position of an object using the motion component enhanced image.

According to a third aspect of the present invention, there is provided a non-transitory computer-readable storage medium which stores a program for causing a computer to execute a control method for an image processing apparatus that detects a predetermined object in a video, the control method comprising: generating a reduced image of a pre-set size from an image of a frame included in the video; generating a motion component enhanced image based on a current reduced image expressing a current frame obtained by the generating a reduced image, a first reduced image from a predetermined length of time before the current reduced image, and a second reduced image from a predetermined length of time before the first reduced image; and determining a position of an object using the motion component enhanced image.

According to a fourth aspect of the present invention, there is provided a system comprising a camera that shoots a video overlooking a field for a sports competition and an image processing apparatus that performs image processing for extracting a region for output from the video obtained by the camera, wherein the image processing apparatus includes: a reducing unit configured to generate a reduced image of a pre-set size from an image of a frame included in the video received from the camera; a generating unit configured to generate a motion component enhanced image based on a current reduced image expressing a current frame obtained by the reducing unit, a first reduced image from a predetermined length of time before the current reduced image, and a second reduced image from a predetermined length of time before the first reduced image; a determining unit configured to determine a position of an object using the motion component enhanced image obtained by the generating unit; and a trimming unit configured to determine and trimming a region to be cut out from the video based on the position of the object determined by the determining unit.

According to a fifth aspect of the present invention, there is provided a learned data generation method for generating learned data to be input to a learning model based on supervisory data, the learned data generation method comprising: changing a color tone of a frame image included in the supervisory data and generating a color tone-changed image; and generating a motion component enhanced image based on a current changed image expressing a current frame obtained in the changing, a first frame image from a predetermined length of time before the current changed image, and a second frame image from a predetermined length of time before the first frame image, wherein the changing is performed prior to the generating.

According to a sixth aspect of the present invention, there is provided a learned data generation method for generating learned data to be input to a learning model based on supervisory data, the learned data generation method comprising: adding noise to a frame image included in the supervisory data and generating a noise-added image; and of generating a motion component enhanced image based on a current added image expressing a current frame obtained in the adding, a first frame image from a predetermined length of time before the current added image, and a second frame image from a predetermined length of time before the first frame image, wherein the adding is performed prior to the generating.

According to a seventh aspect of the present invention, there is provided a learned data generation method for generating learned data to be input to a learning model based on supervisory data, the learned data generation method comprising: removing noise of a frame image included in the supervisory data and generating a noise-removed image; and generating a motion component enhanced image based on a current removed image expressing a current frame obtained in the removing, a first frame image from a predetermined length of time before the current removed image, and a second frame image from a predetermined length of time before the first frame image, wherein the removing is performed prior to the generating.

According to an eighth aspect of the present invention, there is provided a learned data generation method for generating learned data to be input to a learning model based on supervisory data, the learned data generation method comprising: performing sharpness processing on a frame image included in the supervisory data and generating a sharpness image; and generating a motion component enhanced image based on a current expanded image expressing a current frame obtained in the performing sharpness processing, a first frame image from a predetermined length of time before the current expanded image, and a second frame image from a predetermined length of time before the first frame image, wherein the performing sharpness processing is performed prior to the generating.

According to a ninth aspect of the present invention, there is provided a learned data generation method for generating learned data to be input to a learning model based on supervisory data, the learned data generation method comprising: performing smoothing processing on a frame image included in the supervisory data and generating a smoothed image; and generating a motion component enhanced image based on a current expanded image expressing a current frame obtained in the performing smoothing processing, a first frame image from a predetermined length of time before the current expanded image, and a second frame image from a predetermined length of time before the first frame image, wherein the performing smoothing processing is performed prior to the generating.

According to a tenth aspect of the present invention, there is provided a learned data generation method for generating learned data to be input to a learning model based on supervisory data, the learned data generation method comprising: replacing a partial region of a frame image included in the supervisory data with an image different from the frame image and generating a region-replaced image; and generating a motion component enhanced image based on a current replaced image expressing a current frame obtained in the replacing, a first frame image from a predetermined length of time before the current replaced image, and a second frame image from a predetermined length of time before the first frame image, wherein the replacing is performed prior to the generating.

According to an eleventh aspect of the present invention, there is provided a learned data generation method for generating learned data to be input to a learning model based on supervisory data, the learned data generation method comprising: generating a motion component enhanced image based on a current frame image expressing a current frame obtained from a frame image included in the supervisory data, a first frame image from a predetermined length of time before the current frame image, and a second frame image from a predetermined length of time before the first frame image; and transforming a shape of the motion component enhanced image and generating a shape-transformed image, wherein the transforming is performed after the generating.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention. Note that the same reference numerals denote the same or like components throughout the accompanying drawings.

FIG. 1 is a system diagram illustrating machine learning according to a first embodiment.

FIG. 2 is a diagram illustrating the hardware configuration of an image processing apparatus and a learning server according to the first embodiment.

FIG. 3 is a diagram illustrating a software configuration according to the first embodiment.

FIG. 4 is a conceptual diagram illustrating a learning network according to first and second embodiments.

FIG. 5 is a diagram illustrating operations related to sending and receiving between apparatuses in the system according to the first and second embodiments.

FIG. 6A is a flowchart illustrating a processing sequence performed by the image processing apparatus according to the first and second embodiments.

FIG. 6B is a flowchart illustrating a processing sequence performed by a data collection server according to the first and second embodiments.

FIG. 6C is a flowchart illustrating a processing sequence performed by the learning server according to the first and second embodiments.

FIG. 7 is a schematic diagram illustrating an example of the installation of the system according to the first embodiment.

FIG. 8 is a diagram illustrating an example of an overhead image according to the first embodiment.

FIG. 9 is a schematic block diagram according to the first embodiment.

FIG. 10 is a diagram illustrating processing performed by an object detection unit according to the first and second embodiments.

FIG. 11 is a flowchart illustrating processing related to motion enhancement processing, which is a characteristic of the present disclosure, according to the first and second embodiments.

FIG. 12A is a diagram illustrating operations performed by a motion component extraction unit according to the first and second embodiments.

FIG. 12B is a diagram illustrating operations performed by the motion component extraction unit according to the first and second embodiments.

FIG. 12C is a diagram illustrating operations performed by the motion component extraction unit according to the first and second embodiments.

FIG. 13A is a diagram illustrating operations performed by the motion component extraction unit to extract a motion component in a current frame, according to the first and second embodiments.

FIG. 13B is a diagram illustrating operations performed by the motion component extraction unit to extract a motion component in the current frame, according to the first and second embodiments.

FIG. 13C is a diagram illustrating operations performed by the motion component extraction unit to extract a motion component in the current frame, according to the first and second embodiments.

FIG. 13D is a diagram illustrating operations performed by the motion component extraction unit to extract a motion component in the current frame, according to the first and second embodiments.

FIG. 14A is a diagram illustrating operations performed by the motion component extraction unit to generate a current frame in which a motion component is emphasized, according to the first and second embodiments.

FIG. 14B is a diagram illustrating operations performed by the motion component extraction unit to generate a current frame in which a motion component is emphasized, according to the first and second embodiments.

FIG. 14C is a diagram illustrating operations performed by the motion component extraction unit to generate a current frame in which a motion component is emphasized, according to the first and second embodiments.

FIG. 15 is a schematic diagram illustrating a system according to the second embodiment.

FIG. 16 is a diagram illustrating a user-designated region according to the second embodiment.

FIG. 17 is a schematic block diagram according to the second embodiment.

FIG. 18 is a flowchart illustrating a processing sequence performed by the learning server according to a third embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

A first embodiment of the present invention will be described hereinafter. The present embodiment will describe, as an example, a case where a shot video is generated by using an object detection method, described below, to automatically crop out a region of interest in a game from the shot video, at an angle of view in which the entirety of a basketball court is visible. Note that in the present embodiment, using a basketball court (a basketball game) as the subject to be shot is merely an example embodying the technical content, and the subject to be shot is not particularly limited.

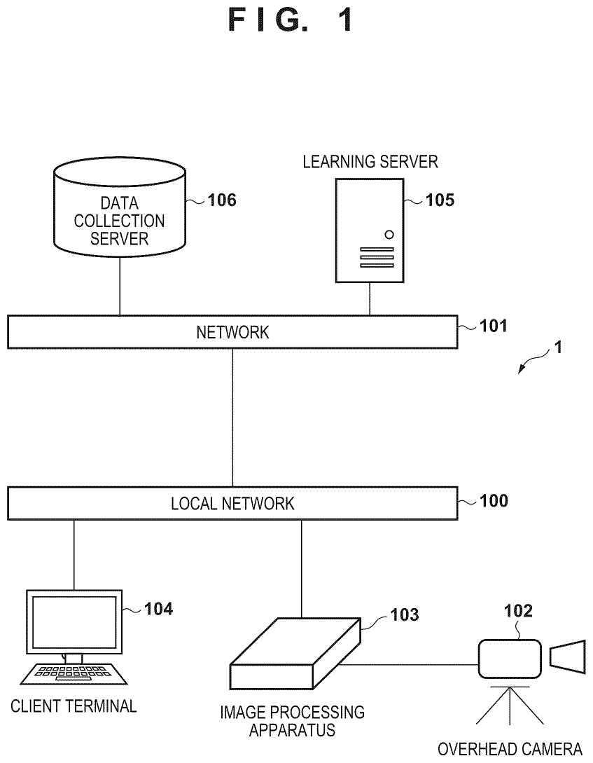

FIG. 1 is a diagram illustrating the configuration of a system 1 including an image processing apparatus 103 that performs the object detection method according to the present first embodiment.

In FIG. 1, the system 1 includes a local network 100, a network 101, an overhead camera 102, the image processing apparatus 103, a client terminal 104, a learning server 105, and a data collection server 106.

The local network 100 is a network to which the image processing apparatus 103, the client terminal 104, and the like are connected, and the image processing apparatus 103 and the client terminal 104 can communicate with each other over the local network 100.

The network 101 is a network to which the local network 100 is connected, and devices connected to the local network 100 can communicate with each other over the network 101. Devices connected to the local network 100 can also communicate with the learning server 105, the data collection server 106, or the like, which are connected to the network 101.

The overhead camera 102 obtains a shot video from a defined range, and outputs the obtained shot video to the image processing apparatus 103. The overhead camera 102 is assumed to obtain the video at 30 frames per second (30 fps), but the framerate is not particularly limited.

The image processing apparatus 103 detects a predetermined object appearing in the video from the shot video input by the overhead camera 102. Here, “detection” refers to processing for identifying the coordinates of the predetermined object and the type of the object. The present embodiment assumes that a basketball and a player in a basketball game are detected as predetermined objects.

The client terminal 104 is an apparatus that instructs the sending and receiving of data among devices. The learning server 105 is an apparatus that generates machine learning data. The data collection server 106 is an apparatus that stores supervisory data for learning in the learning server 105.

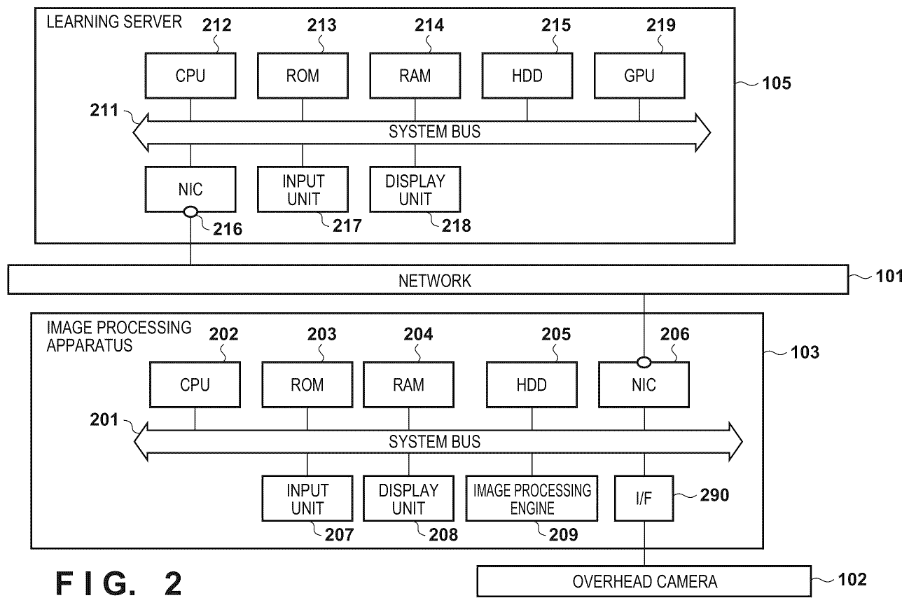

FIG. 2 illustrates the hardware configuration of the image processing apparatus 103 and the learning server 105, which are constituent members of the system 1. It should be noted that, for the sake of simplicity, only the image processing apparatus 103, the learning server 105, and the network 101 of the system 1 are illustrated, and other members have been omitted.

As illustrated in FIG. 2, the image processing apparatus 103 includes a CPU 202, a ROM 203, a RAM 204, an HDD 205, a Network Interface Card (NIC) 206, an input unit 207, a display unit 208, an image processing engine 209, and an interface (I/F) 290, which are connected to each other by a system bus 201.

The CPU 202 controls the image processing apparatus 103 as a whole. The CPU 202 controls the units described later, and performs operations based on inputs from the input unit 207, data received from the NIC 206, and the like. The ROM 203 is a non-volatile memory, and holds programs that control the image processing apparatus 103, various types of parameters, and the like. When the image processing apparatus 103 is turned on, the CPU 202 loads a program from the ROM 203 and starts control of the image processing apparatus 103. The ROM 203 is constituted by a flash memory, for example.

The RAM 204 is a rewritable memory, and is used as a work area by programs that control the image processing apparatus 103. A volatile memory (DRAM) using a semiconductor device is used for the RAM 204, for example.

The HDD 205 (a storage unit) stores image data, a database for searching the image data, and the like. Although the embodiment describes a hard disk drive (HDD) using a magnetic storage system, another external storage device such as a solid-state drive (SSD) using a semiconductor device may be used as the HDD 205.

The NIC 206 is a network interface controller (NIC), and is used for the image processing apparatus 103 to communicate with other apparatuses over the network 101. For example, a controller based on Ethernet (registered trademark) or a communication method standardized in the IEEE 802.3 series is used as the NIC 206.

The input unit 207 is used when a user (operator) of the image processing apparatus 103 operates the image processing apparatus 103. A keyboard is used as the input unit 207, for example. The image processing apparatus 103 of the present invention is assumed to operate as a server on the network 101, and thus the input unit 207 is used only when the image processing apparatus 103 is started up, undergoing maintenance, or the like.

The display unit 208 is used to display an operating state of the image processing apparatus 103. A liquid crystal display (LCD) is used as the display unit 208, for example. Note that because the image processing apparatus 103 of the present invention is assumed to operate as a server on the network 101, the display unit 208 may be omitted.

The image processing engine 209 performs image processing such as reduction processing, motion enhancement processing (described later), and the like on image data read out from the RAM 204, and stores the result in the RAM 204 again. Although the present embodiment assumes that the various types of image processing are performed through operations by the CPU 202, the configuration is not limited thereto. For example, the image processing apparatus 103 may be newly provided with a GPU, and various computational processes may be performed by the GPU.

The interface 290 is used to connect the overhead camera 102 and the image processing apparatus 103. The image processing apparatus 103 receives shot video data from the overhead camera 102 via the interface 290. Although the interface 290 may be any interface capable of communicating with the overhead camera 102, and the type thereof is not particularly limited, the interface 290 is typically a Universal Serial Bus (USB) interface. Note that the overhead camera 102 may be a network camera, as long as the network bandwidth permits. In this case, the image processing apparatus 103 receives the shot video from the overhead camera 102 via the NIC 206.

In FIG. 2, the learning server 105 includes a CPU 212, a ROM 213, a RAM 214, an HDD 215, a NIC 216, an input unit 217, a display unit 218, and a GPU 219, which are connected to each other by a system bus 211.

The CPU 212 controls the learning server 105 as a whole. The CPU 212 controls the units described later, and performs operations based on inputs from the input unit 217, data received from the NIC 216, and the like.

The ROM 213 is a non-volatile memory, and holds programs that control the learning server 105. When the learning server 105 is turned on, the CPU 212 loads programs from the ROM 213 and starts control of the learning server 105. The ROM 213 is constituted by a flash memory, for example.

The RAM 214 is a rewritable memory, and is used as a work area by programs that control the learning server 105. A volatile memory (DRAM) using a semiconductor device is used for the RAM 214, for example.

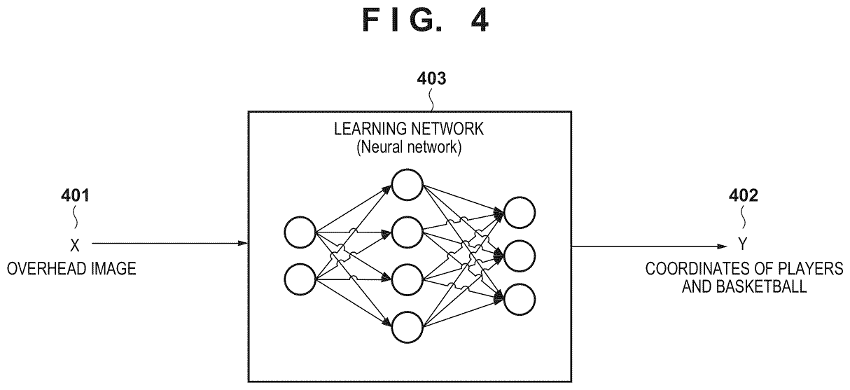

The HDD 215 stores a learning network (dictionary data) 403 (FIG. 4) that estimates the position of a predetermined object, and the type of the object, in the image data through an image recognition function. Although the embodiment describes a hard disk drive (HDD) using a magnetic storage system, another external storage device such as a solid-state drive (SSD) using a semiconductor device may be used as the HDD 205.

The NIC 216 is a network interface controller, and is used for the learning server 105 to communicate with other apparatuses over the network 101. For example, a controller based on Ethernet (registered trademark) or a communication method standardized in the IEEE 802.3 series is used as the NIC 216.

The input unit 217 is used when a user (operator) of the learning server 105 operates the learning server 105. A keyboard is used as the input unit 217, for example. The learning server 105 is assumed to operate as a server on the network 101, and thus the input unit 217 is used only when the learning server 105 is started up, undergoing maintenance, or the like.

The display unit 218 is used to display an operating state of the learning server 105. A liquid crystal display (LCD) is used as the display unit 218, for example. Note that because the learning server 105 of the present invention is assumed to operate as a server on the network 101, the display unit 218 may be omitted.

The GPU 219 is a unit used for performing parallel computation processing on data. Performing processing using the GPU 219 is effective when using a learning network to perform multiple iterations of learning, such as with deep learning, when performing a large number of product-sum operations for estimation, and the like. Although LSIs called Graphics Processing Units are typically used for the GPU 219, an equivalent function may be implemented by a reconfigurable logic circuit called an FPGA.

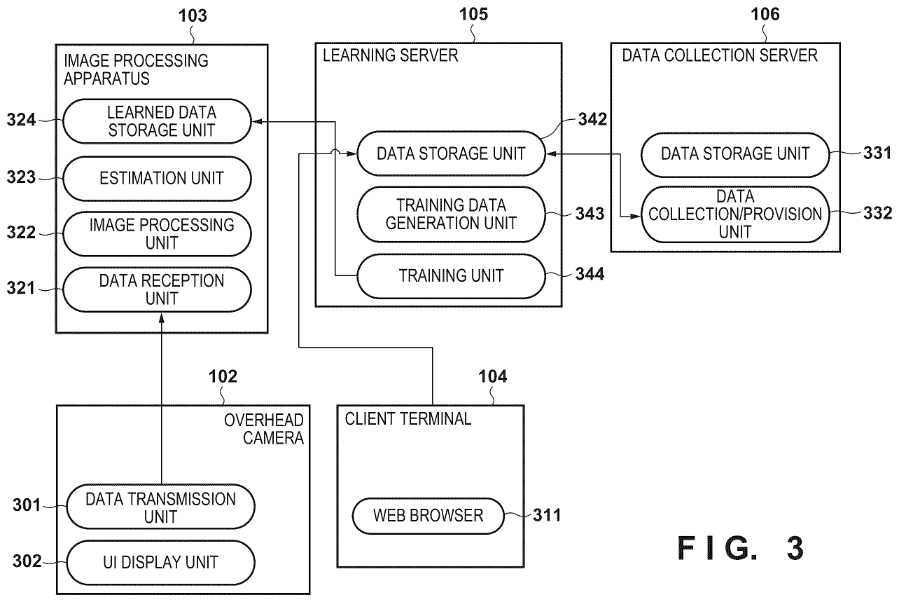

FIG. 3 is a diagram illustrating software configurations running on the respective apparatuses constituting the system 1. This software configuration is realized by utilizing the hardware resources and programs described with reference to FIG. 2. Note that general-purpose software configurations such as an operating system are not illustrated in this software configuration.

The software of the overhead camera 102 is constituted by a data transmission unit 301 and a UI display unit 302. The data transmission unit 301 has a software function for transmitting, to a data reception unit 321, image data selected by the UI display unit 302 (described later) from among the image data held by the overhead camera 102. The data transmission unit 301 also has a software function for transmitting shot data to the data reception unit 321 based on instructions from the image processing apparatus 103. The UI display unit 302 has a software function for providing a user interface for displaying any of the image data held by the overhead camera 102 so as to be selectable by the user.

The software of the image processing apparatus 103 is constituted by the data reception unit 321, an image processing unit 322, an estimation unit 323, and a learned data storage unit 324. The data reception unit 321 has a software function for transmitting and receiving data to and from the overhead camera 102, the client terminal 104, and the like. For example, the data reception unit 321 receives shot video (image data) from the overhead camera 102 via the interface 290, the NIC 206, or the like, and outputs the shot video (image data) to the image processing unit 322. The image processing unit 322 applies reduction processing, motion detection processing, or the like (described later) to the input image data, and outputs the post-image processing shot data to the estimation unit 323. The estimation unit 323 has a software function for detecting the coordinates of a basketball, players, and the like, as well as the types thereof, from the shot data input from the image processing unit 322, using a learning network 403 stored in the HDD 205 by the learned data storage unit 324.

The software of the client terminal 104 is constituted by a web browser 311. The web browser 311 has a software function for forming and displaying data obtained from the data reception unit 321 of the image processing apparatus 103 such that the data is visible to the user of the client terminal 104. The web browser 311 also has a software function for communicating user operations (searching for and displaying image data and the like) to the data reception unit 321 of the image processing apparatus 103.

The software of the learning server 105 is constituted by a data storage unit 342, a training data generation unit 343, and a training unit 344. The data storage unit 342 has a software function for accumulating image data received from a data collection/provision unit 332 (described later), training image data generated by the training data generation unit 343 (described later), and searching for and managing the accumulated image data. The image data is accumulated by being stored in the HDD 215. The training data generation unit 343 generates training image data in which motion enhancement processing (described later) has been applied to the image data stored in the data storage unit 342. The generated training image data is stored in the HDD 215 by the data storage unit 342. The training unit 344 trains the learning network 403 based on the training image data. The generated learning network 403 is transmitted to the learned data storage unit 324 of the image processing apparatus 103 and is recorded in the RAM 204.

FIG. 4 is a conceptual diagram illustrating an input/output structure using the learning network 403. It should be understood that the learning network 403 has the same structure in both the present embodiment and in the embodiments described later.

As illustrated in FIG. 4, the learning server 105 learns by inputting an overhead image serving as supervisory data into the input of the learning network 403, which is constituted by a neural network, and outputting the coordinates of the players and the basketball. Although FIG. 4 illustrates a case where the learning network 403 is constituted by a single learning network, a plurality of learning networks may be prepared in accordance with metadata to be estimated from image data 401.

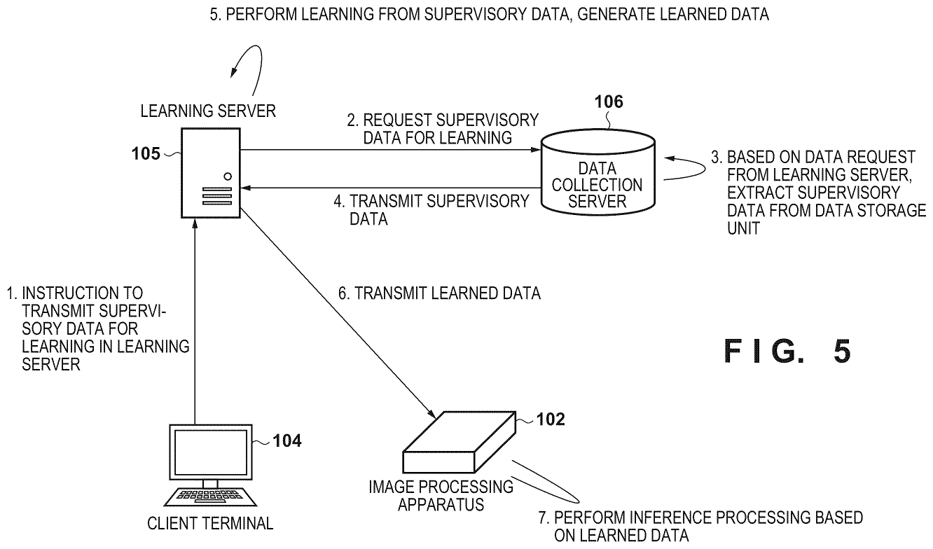

FIG. 5 is a diagram illustrating operations performed by the system 1 as a whole up to when the learning network 403 illustrated in FIG. 4 is trained and is used in the present embodiment.

The user who uses the system 1 operates the client terminal 104 to instruct the data storage unit 342 to transmit supervisory data for the learning in the learning server 105.

The data storage unit 342 makes a request for the supervisory data for learning to the data collection/provision unit 332 based on the instruction to transmit the supervisory data from the client terminal 104.

The data collection server 106 extracts the supervisory data from the data storage unit 342 in response to an instruction to transmit the supervisory data from the learning server 105. The data collection/provision unit 332 then transmits the supervisory data to the data storage unit 342.

The learning server 105 performs predictive learning using the supervisory data received by and held in the data storage unit 342, and generates learned data. The learning server 105 then transmits the generated learned data to the image processing apparatus 103, and the learned data is held in the learned data storage unit 324. The image processing apparatus 103 then performs inference processing based on the learned data that has been stored.

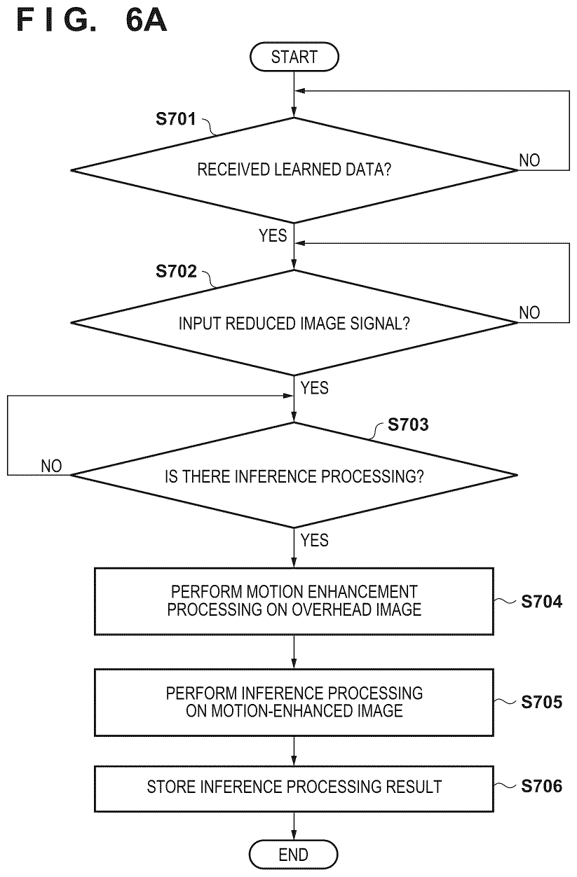

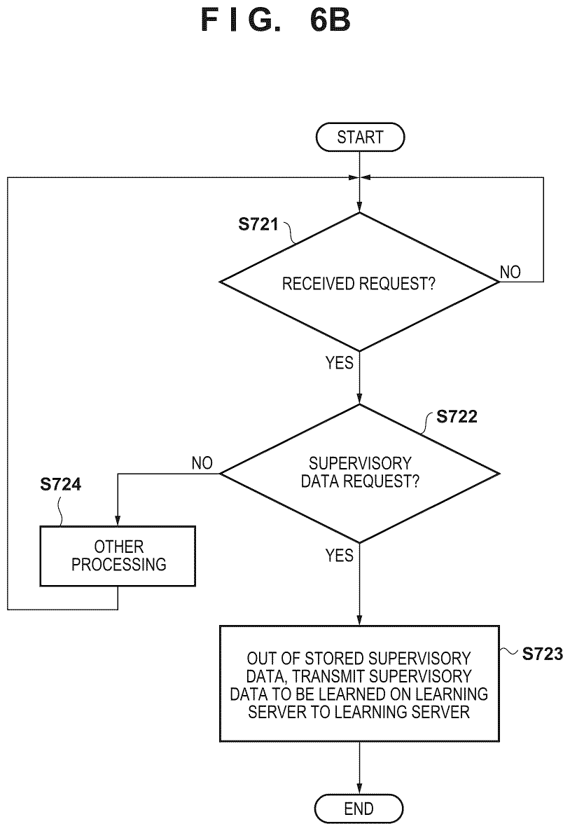

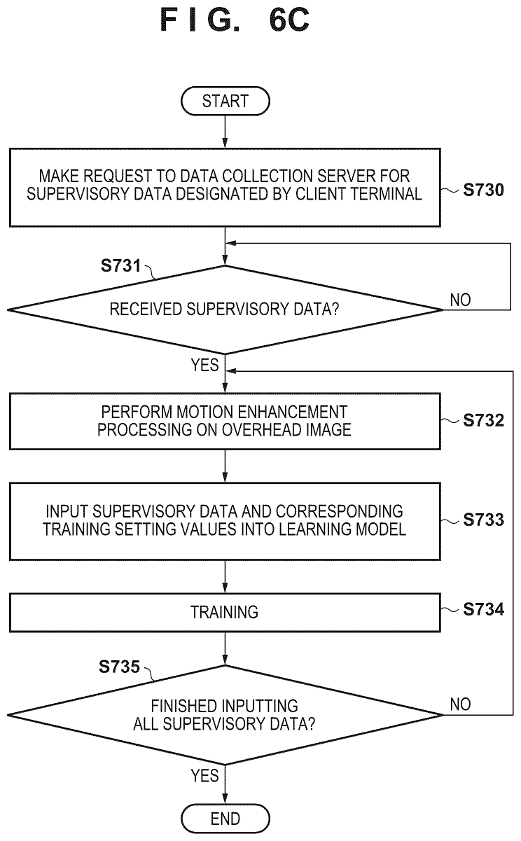

The specific flow of learning and inference by the learning network 403 will be described next with reference to FIGS. 6A to 6C.

FIG. 6B is a flow of processing by the data collection server 106. Processing performed by the data collection/provision unit 332 of the data collection server 106 will be described next with reference to FIG. 6B.

In S721, the data collection/provision unit 332 determines whether a request has been made by the learning server 105. If a request has been made, in S722, the data collection/provision unit 332 determines whether the request is for supervisory data. If the request is not for the supervisory data, the sequence branches to S724, where the data collection/provision unit 332 performs processing according to the type of the received request. On the other hand, if the request is for the supervisory data, the data collection/provision unit 332 moves the sequence to S723. The request for the supervisory data in the present embodiment includes an overhead image of the entirety of a basketball court and values for the coordinates of players and a basketball in that image. In S723, the data collection/provision unit 332 reads out the supervisory data of the requested type from the data storage unit 331 and transmits the data to the learning server 105.

As illustrated in FIG. 4, the learning server 105 generates the learned data by taking the overhead image serving as supervisory data as the input of the learning network 403, which is constituted by a neural network, and outputting the coordinates of the players and the basketball. At this time, the GPU 219 can perform efficient operations by processing more data in parallel, and thus when the learning server 105 performs multiple iterations of learning using a learning model such as deep learning, it is effective to perform the processing using the GPU 219.

In the present embodiment, the learning processing performed by the learning server 105 uses the GPU 219 in addition to the CPU 212. When executing a learning program that includes a learning model, the learning server 105 performs the learning by the CPU 212 and the GPU 219 operating cooperatively. Note that the operation for the learning processing may be performed only by the CPU 212 or the GPU 219.

FIG. 6C is a flow of processing by the learning server 105. Processing performed by the learning server 105 will be described hereinafter with reference to FIG. 6C.

First, in S730, the learning server 105 requests the supervisory data from the data collection server 106. Then, in S731, the learning server 105 waits to receive the supervisory data. If the supervisory data has been received, the data storage unit 342 stores that data in the RAM 214.

Next, in S732, the training data generation unit 343 generates a motion-enhanced image by performing motion enhancement processing (described later) on the received data, and stores the motion-enhanced image in the RAM 214. The specific motion enhancement processing (S704) and the motion-enhanced image will be described later with reference to FIGS. 11 to 14.

Next, in S733, the training unit 344 inputs the received supervisory data and training setting values corresponding to the supervisory data into the learning model. Here, the learning model is the learning network 403 mentioned earlier. In the present embodiment, the training setting values are assumed to be parameter values for data augmentation performed on the signal input to the learning network 403.

In S734, the training unit 344 performs training using the learning network 403. When it is determined in S735 that the input of all the supervisory data is complete, the learning server 105 ends the learning processing.

Additionally, in the training performed by the training unit 344 in step S734, an error detection unit and an update unit may be newly provided, and those units may execute. The error detection unit obtains error between output data output from an output layer of the neural network in response to the input data input to the input layer, and the supervisory data. The error detection unit may calculate the error between the output data from the neural network and the supervisory data using a loss function.

Based on the error obtained by the error detection unit, the update unit updates connection weight coefficients and the like between nodes of the neural network such that the error becomes smaller. The update unit updates the connection weight coefficients and the like using error backpropagation, for example. Error backpropagation is a method for adjusting connection weight coefficients and the like between the nodes of a neural network such that the stated error becomes smaller.

The image processing apparatus 103 performs machine learning inference processing based on the learned data generated by the learning server and stored in the HDD 205 and the ROM 203.

Specifically, a reduced image signal processed by the image processing unit 322 is input to the CPU 202, and inference processing is performed by the CPU 202 using the learned data and a program. Like the learning model, the inference processing is implemented by a neural network.

The flowchart in FIG. 6A illustrates the flow of processing performed by the image processing apparatus 103. The processing performed by the image processing apparatus 103 will be described hereinafter with reference to FIG. 6A.

First, in S701, the learned data storage unit 324 receives the learned data from the learning server 105 and stores that data in the RAM 204. Thereafter, when performing the inference processing, reference is made to whether learned data is stored in the RAM 204, and if so, the sequence moves to S702.

In S702, the estimation unit 323 determines whether a reduced image signal 151 (a reduced image of a frame shot by the overhead camera 102) has been input. The sequence moves to S703 if the estimation unit 323 determines that the reduced image signal 151 has been input.

In S703, the image processing apparatus 103 determines whether the user has instructed the inference processing to start, and if it is determined that the inference processing has been instructed to start, the sequence moves to S704. In S704, the image processing apparatus 103 performs motion enhancement processing on the reduced image signal that has been input. Then, in S705, the estimation unit 323 performs inference processing by inputting a motion-enhanced image obtained by performing the motion enhancement processing mentioned above on the learned data stored in the RAM 204. Then, in S706, the estimation unit 323 obtains and stores the coordinate positions of the players and the ball as outputs. The estimation results are stored in the HDD 205, for example. The specific motion enhancement processing (S705) and the motion-enhanced image will be described later with reference to FIGS. 11 to 14.

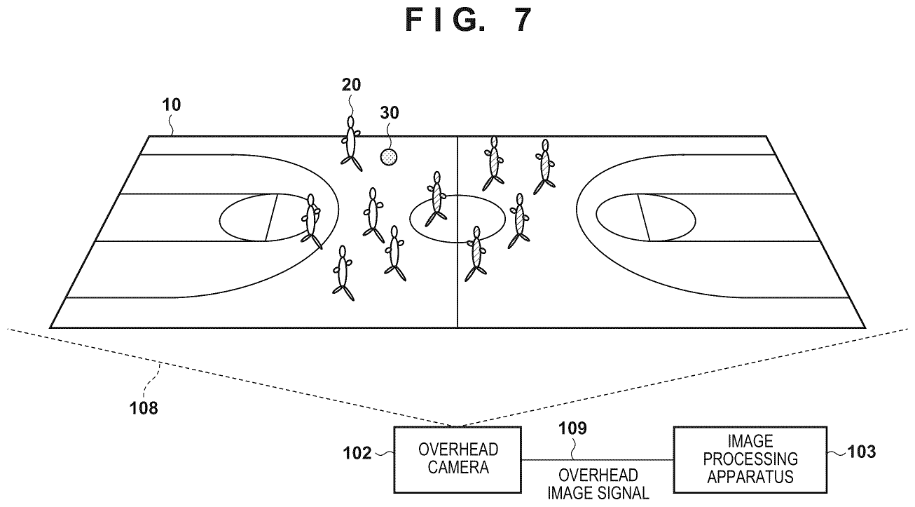

FIG. 7 is a schematic diagram illustrating an example of the actual deployment of the system 1.

The overhead camera 102 is assumed to have optical characteristics such that a basketball court 10 containing players 20 and a ball 30 falls completely within a shooting angle of view 108. The resolution of an image signal 109 captured by the overhead camera 102 is assumed to be 3,840 horizontal pixels×2,160 vertical pixels.

The overhead camera 102 supplies the captured image to the image processing apparatus 103 as an overhead image signal 109. Although the output of the image involves supplying the image to the image processing apparatus 103 via the USB interface in this embodiment, the image may be output from an output terminal such as HDMI (High-Definition Multimedia Interface) (registered trademark) or Serial Digital Interface (SDI) included in the overhead camera 102, for example. The overhead image signal 109 may be an image obtained by exporting an image which has been captured and recorded in a recording medium within the overhead camera.

The image processing apparatus 103 applies object detection processing to the overhead image signal 109 received from the overhead camera 102, and obtains the coordinates and types of the players and the basketball in the overhead image signal 109. The image processing apparatus 103 then generates a shot image signal 261 (described later) based on the obtained coordinate values.

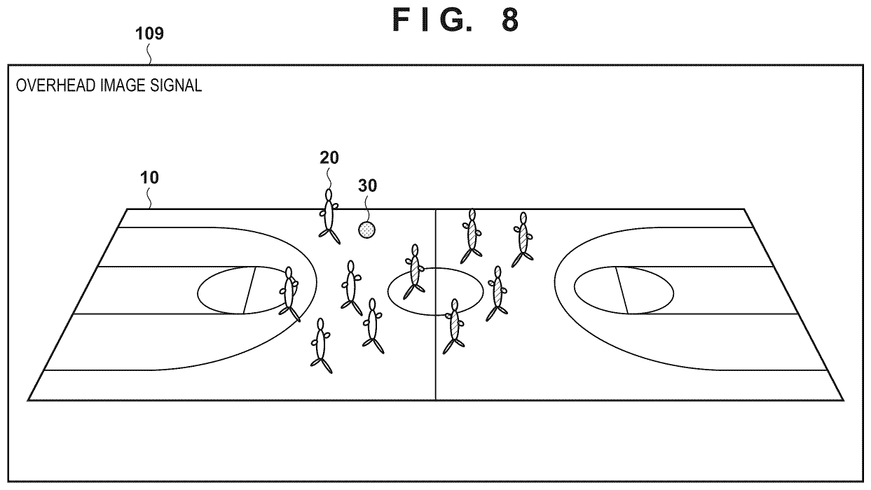

FIG. 8 is a schematic diagram of the overhead image signal 109 obtained by the overhead camera 102. As described earlier, the overhead image signal 109 is a video in which the basketball court 10 falls completely within the shooting angle of view, and the movements of the players 20 and the ball 30 on the basketball court 10 can be seen.

FIG. 9 is a diagram illustrating specific processing performed by the image processing unit 322 and the estimation unit 323 in the image processing apparatus 103. Note that in FIG. 9, the estimation unit 323 is illustrated as an object detection unit 240 that detects the players and the ball from the overhead image signal 109.

First, an image reduction unit 210 is input with the overhead image signal 109 from the overhead camera 102, performs reduction processing, and outputs the reduced image signal 151. The image resolution of the overhead image signal 109 is 3,840 horizontal pixels by 2,160 vertical pixels in this embodiment, but when this resolution is input to the object detection unit 240, the large resolution increases the processing load on the object detection unit 240. The image reduction unit 210 of this embodiment reduces the 3,840 horizontal pixels by 2,160 vertical pixels, which is the resolution of the overhead image signal 109, to an image of 400 horizontal pixels and 400 vertical pixels, and outputs the result as the reduced image signal 151. Note that the reduced image resolution is not limited to the above, and may be determined according to the processing capabilities of the object detection unit 240, or a reduction ratio thereof may be set by the user.

A motion component extraction unit 220 extracts a motion component in the current frame by computing the reduced image signal 151 from a total of three frames, namely the current frame and frames input in the past, and outputs the extracted motion component to a motion component computation unit 230 as a motion component image signal 221.

The motion component computation unit 230 obtains a motion component enhanced image signal 231 in which the motion component is enhanced by processing the motion component image signal 221 and the reduced image signal 151 in the current frame, and outputs the obtained signal to the object detection unit 240.

The object detection unit 240 performs inference processing on the motion component enhanced image signal 231, and recognizes the coordinates and types of the players 20 and the ball 30. The detection result from the inference processing is expressed in rectangular coordinate value format, as illustrated in FIG. 10. A plurality of player coordinate values are detected, as indicated in FIG. 10, and are output as multiple player coordinates 152 from the object detection unit 240.

The ball coordinate values indicated in FIG. 10 are output as ball coordinates 153 from the object detection unit 240. Here, the coordinates of the players and the ball are the coordinates of upper-left, lower-left, upper-right, and lower-right coordinate positions of a bounding quadrangle (or a quadrangle in which a bounding quadrangle has been enlarged in four directions by values set in advance).

The object detection unit 240 supplies the plurality of player coordinates 152 and the ball coordinates 153 to a shooting angle of view determination unit 250 collectively as object coordinates 241.

The shooting angle of view determination unit 250 calculates parameters for determining the shooting angle of view based on the plurality of player coordinates 152 and the ball coordinates 153 included in the object coordinates 241. The shooting angle of view determination unit 250 calculates a difference between a minimum value (a left end of trimming) and a maximum value (a right end of trimming) of the x-coordinate, and a center of gravity thereof, within a size of an angle of view encompassing all of the plurality of player coordinates 152 and the ball coordinates 153, and transmits the result to a trimming unit 260 as shooting parameters 251. By taking the stated difference value as the horizontal width of the angle of view and the stated center of gravity as the center of the angle of view, a shooting angle of view including all the players 20 and the ball 30 can be realized in the shot image signal 261 determined based on those values.

Based on the stated horizontal width of the angle of view and the center of the angle of view included in the shooting parameters 251, the trimming unit 260 generates a cropped video from the unreduced overhead image signal 109, and outputs that cropped video as the shot image signal 261.

The specific details of the processing by the motion component extraction unit 220 and the motion component computation unit 230, which are characteristic processing according to the present embodiment, will be described here with reference to the flowchart in FIG. 11. The flowchart in FIG. 11 illustrates processing by which the image processing apparatus 103 generates the motion component enhanced image signal 231 using the reduced image signal 151 and outputs the generated signal to the object detection unit 240.

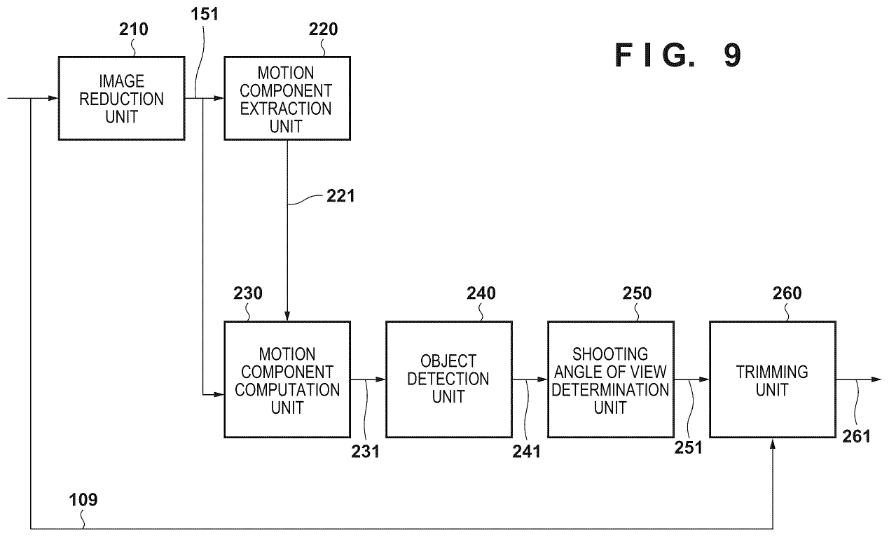

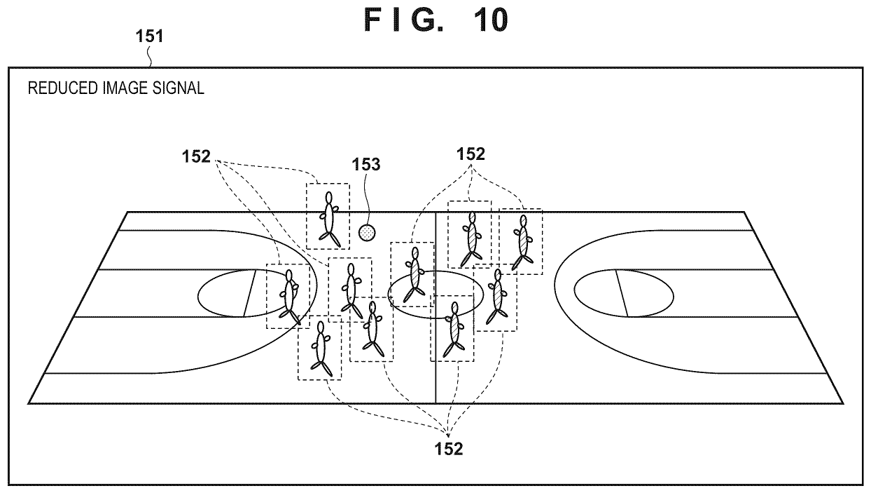

In S301 and S302, the motion component extraction unit 220 obtains shot frames for a plurality of times from the RAM 204, and extracts changes in pixel values through frame computation processing on the shot frames. FIGS. 12A to 12C are diagrams illustrating the results of the frame computation processing performed by the motion component extraction unit 220, and for the sake of simplicity, the following processing will be described using a part of the reduced image signal 151. FIG. 12A illustrates a reduced image signal 151a at a certain time. FIG. 12B illustrates a reduced image signal 151b from a part of the overhead image signal 109 several frames before the timing of the reduced image signal 151a. Because there is a time difference of several frames between FIGS. 12A and 12B, the position of the basketball court 10 does not change, but the positions of the players 20 and the ball 30 do. By calculating the difference between the frames in FIGS. 12A and 12B and calculating the absolute value thereof, it is possible to obtain only motion components in a reduced image signal 151c, such as players 20c and a ball 30c in the shot video, as illustrated in FIG. 12C. Although the present embodiment assumes that the differential processing between the frames is performed on reduced image signals obtained at a time interval of 10 frames, the configuration is not limited thereto, and any length of time may be used as long as the predetermined length of time for applying the differential processing is provided.

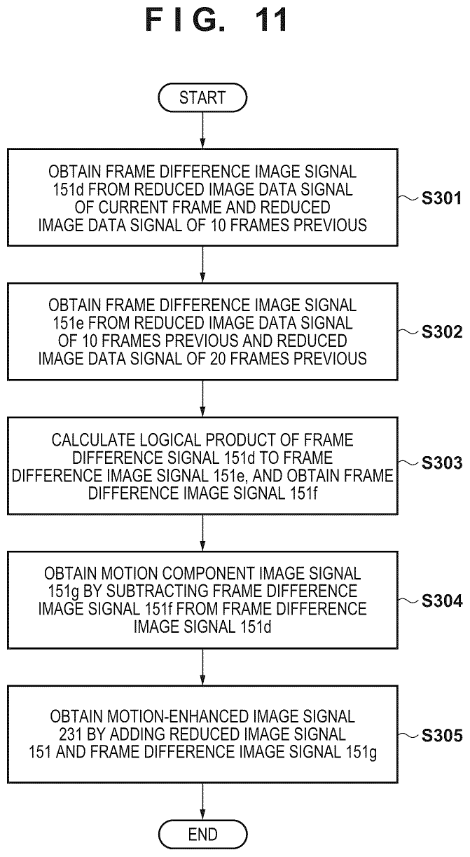

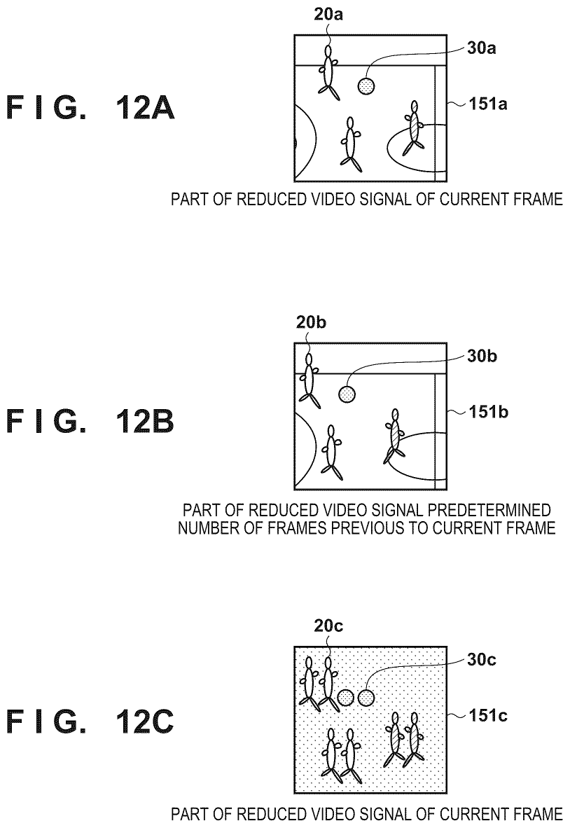

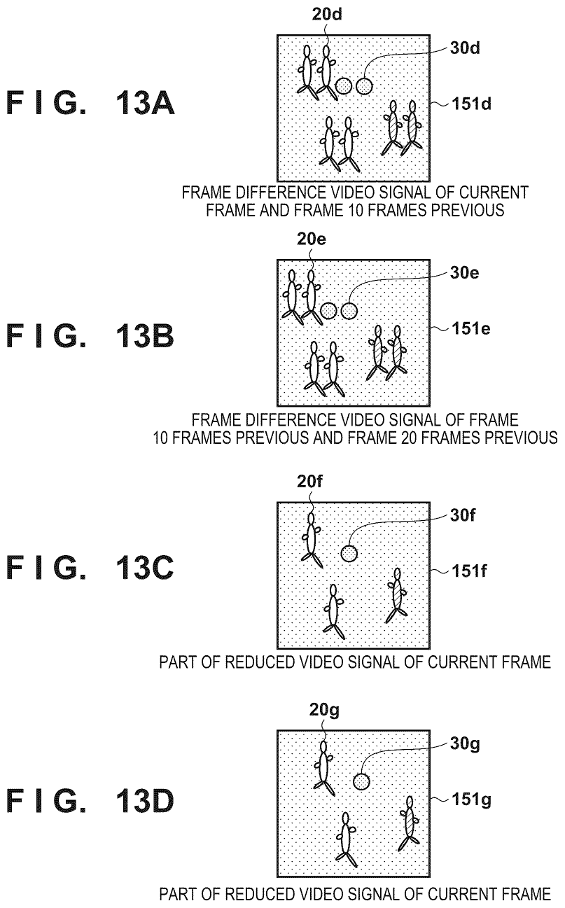

A method for generating the motion component image signal 221 in the current frame, performed by the motion component extraction unit 220 from S301 to S304, will be described next with reference to FIGS. 13A to 13D. Like FIGS. 12A to 12C, the following processing will be described with respect to a part of the reduced image signal 151 for the sake of simplicity.

In S301, the motion component extraction unit 220 obtains a frame difference image signal 151d, illustrated in FIG. 13A, by calculating a difference between the reduced image of the current frame and the reduced image from 10 frames previous. The sequence moves to S302 after the motion component extraction unit 220 obtains the frame difference image signal 151d.

In S302, the motion component extraction unit 220 obtains a frame difference image signal 151e, illustrated in FIG. 13B, by calculating a difference between the reduced image from 10 frames previous and the reduced image from 20 frames previous.

In S303, the motion component extraction unit 220 obtains a frame difference image signal 151f (FIG. 13C), which expresses a motion component in the frame 10 frames previous, by calculating a logical product of the frame difference image signal 151d and the frame difference image signal 151e. The sequence moves to S304 after the motion component extraction unit 220 obtains the frame difference image signal 151f.

In S304, the motion component extraction unit 220 obtains a frame difference image signal 151g (FIG. 13D), which represents only the motion component in the current frame, by subtracting the frame difference image signal 151f from the frame difference image signal 151d. The sequence moves to S305 after the motion component extraction unit 220 outputs the frame difference image signal 151g to the motion component computation unit 230 as the motion component image signal 221.

Next, in S305, the motion component computation unit 230 generates the motion component enhanced image signal 231 by adding the reduced image signal 151 of the current frame and the frame difference image signal 151g, and outputs the generated signal to the object detection unit 240.

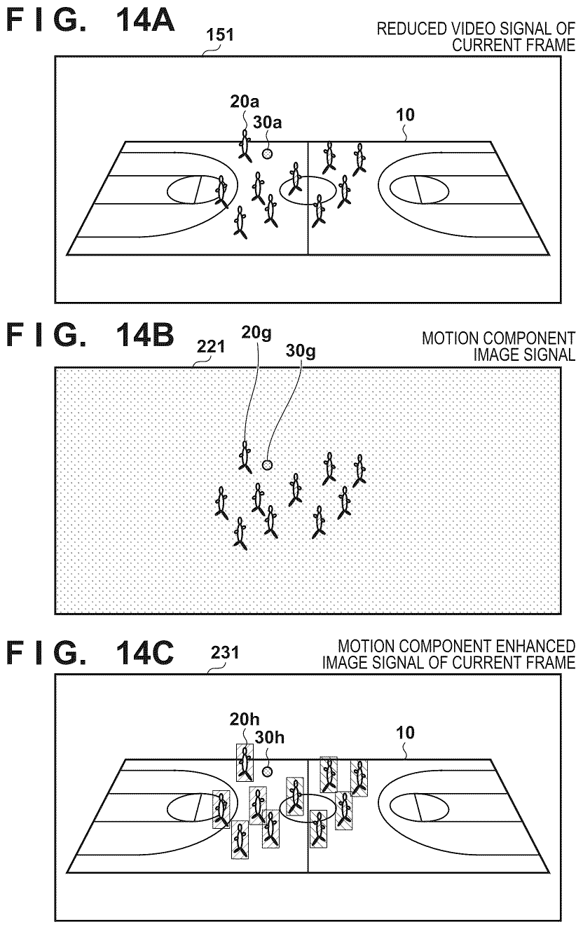

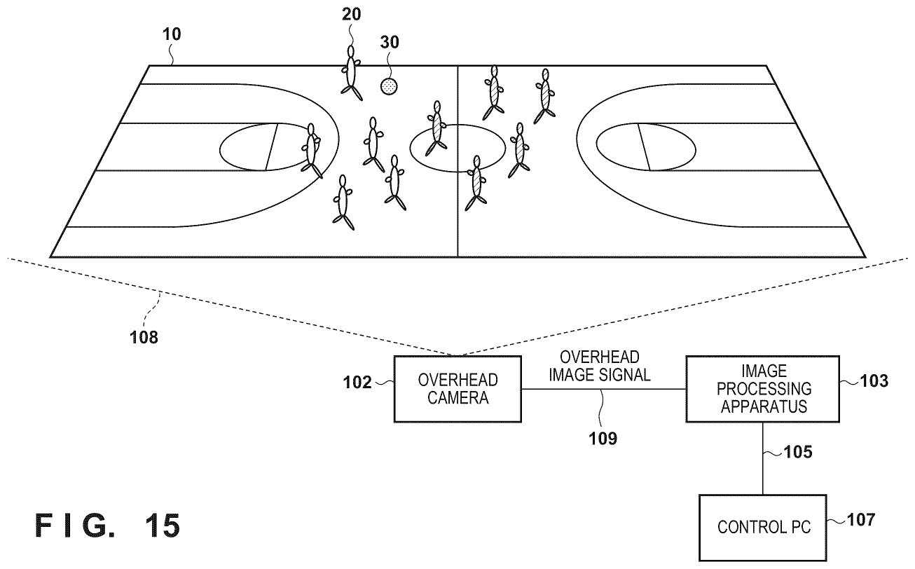

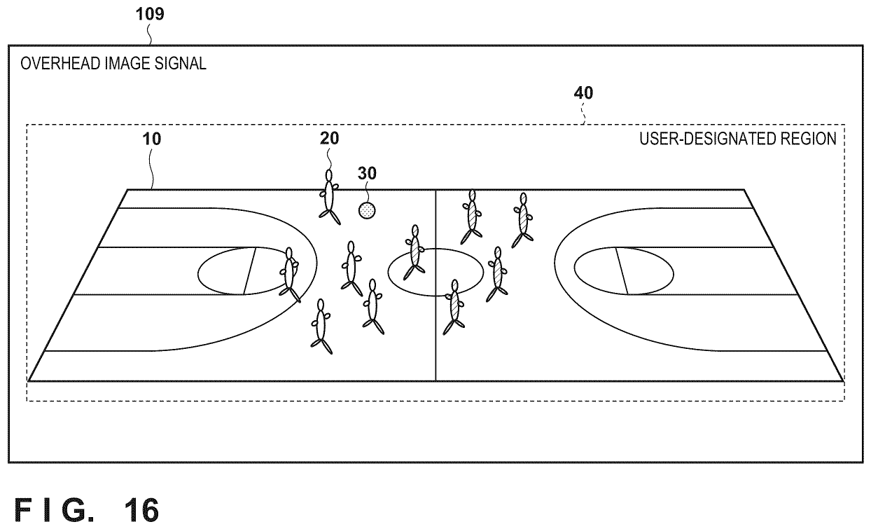

The specific details of the processing performed by the motion component computation unit 230 will be described with reference to FIGS. 14A to 14C.

First, the motion component computation unit 230 obtains the motion component enhanced image signal 231, in which the motion component illustrated in FIG. 14C is enhanced, by adding the values of the reduced image signal 151 of the current frame illustrated in FIG. 14A with the motion component image signal 221 indicating the motion component of the current frame illustrated in FIG. 14B, on a pixel-by-pixel basis. The motion component computation unit 230 outputs the motion component enhanced image signal 231 to the object detection unit 240. At this time, by performing inference processing using the motion component extraction unit 220 and the learning network 403, which has been trained on images similarly subjected to the processing by the motion component computation unit 230 described earlier, the object detection unit 240 can perform the inference processing taking the motion component into account.

Although the present embodiment describes an example in which the motion component computation unit 230 adds the values of the reduced image signal 151a of the current frame and the motion component enhanced image signal 231 of the current frame on a pixel-by-pixel basis, the configuration is not limited thereto. For example, it is conceivable to multiply the values of the reduced image signal 151a of the current frame and the motion component enhanced image signal 231 of the current frame on a pixel-by-pixel basis, perform the stated operations on only pixels for which the value of the motion component enhanced image signal 231 exceeds a threshold, or the like. In other words, the present technique can be applied as long as the motion region in the current frame can be enhanced based on the motion component enhanced image signal 231 extracted by the motion component extraction unit 220.

The first embodiment of the present invention pertaining to the configuration illustrated in FIG. 7 have been described in detail thus far.

However, the present invention is not limited thereto, and may be applied to other sports aside from basketball. For example, when applying the present invention to soccer, the fact that the ball appears smaller may be taken into account, and a plurality of overhead cameras may be prepared to combine detection results after performing the series of processing described above. However, the present invention is not limited thereto, and if the object detection unit 240 detects that the players and the ball have been lost partway through, the coordinate values immediately prior to those objects being lost may be used instead.

This is because if the players overlap with each other, or if the ball is hidden behind a player, those objects may not be detected.

In this manner, it is possible to improve the accuracy by generating a video in which the motion component is enhanced from an image shot of the entire court, and detecting an object based on that video.

Although the present embodiment describes an example in which the trimming unit 260 crops out a part of the overhead image signal 109 at a shooting angle of view including the players 20, the ball 30, and the like based on a result of object detection, the method for obtaining the shot image signal 261 is not limited thereto. For example, a PTZ camera may be newly provided, a control value calculation unit may be newly provided instead of the trimming unit 260, and the shot image signal may be obtained optically by controlling the PTZ (variable pan, tilt, and zoom) camera in accordance with a result of detecting the players 20, the ball 30, or the like. This method makes it possible to generate the shot image signal 261 while preventing a drop in resolution caused by the trimming.

### Second Embodiment

A second embodiment will describe a method in which the object detection accuracy is further improved by the user specifying an object detection target region for a basketball game.

FIG. 15 is a schematic diagram illustrating the actual deployment of the system 1 of the second embodiment. The basic content of the descriptions is the same as in the first embodiment, and thus the present second embodiment will describe a control PC 107, which is a difference from the first embodiment.

The control PC 107 is connected to the image processing apparatus 103 and obtains a shot image from the overhead camera 102 via the image processing apparatus 103, and the user selects a detection target region for the object detection unit 240 in that shot image. The control PC 107 transmits the selected detection target region to the image processing apparatus 103 as a user-designated region 40. Note that the client terminal 104 may be substituted for the control PC 107.

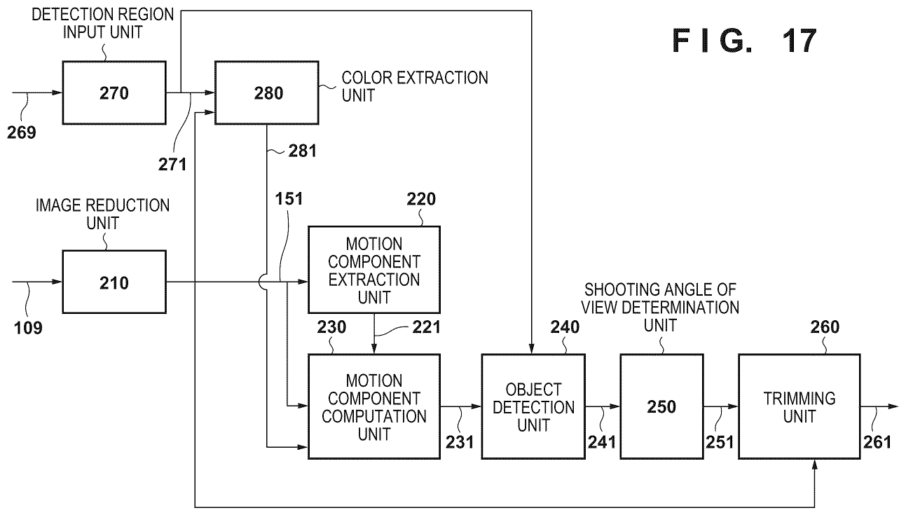

FIG. 16 is a diagram illustrating the positional relationship between the overhead image signal 109 captured by the overhead camera 102 and the user-designated region 40 set by the user of the control PC 107. It is assumed that the user sets the user-designated region 40 by operating a pointing device or the like included in the control PC 107. As illustrated in FIG. 16, it is desirable for the user-designated region 40 to be designated such that the basketball court 10, the players 20, and the ball 30 are included therein. This makes it possible to prevent the false detection of objects in regions where objects cannot be present in an actual game, such as spectator seats, during object detection processing performed by the object detection unit 240 (described later). This information also makes it possible for a color extraction unit 280 (described later) to obtain the color components of the region in which the players 20 and the ball 30 are present.

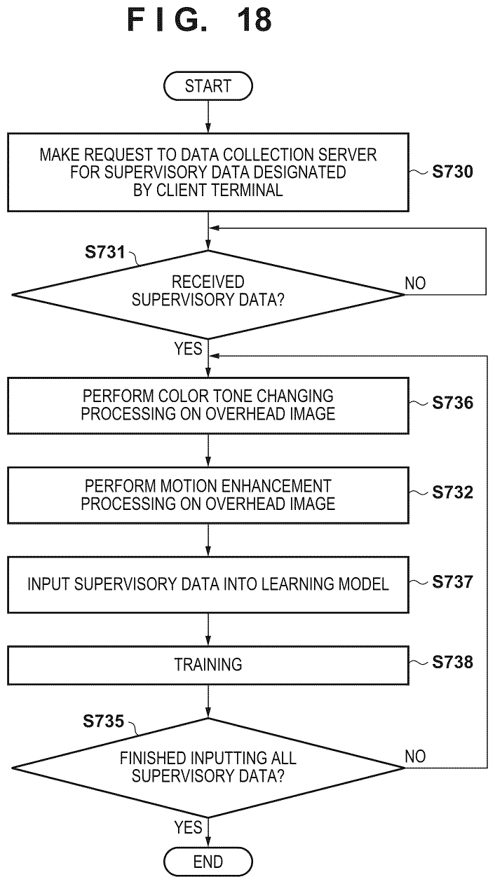

FIG. 17 is a diagram illustrating specific processing performed by the image processing unit 322 included in the image processing apparatus 103. In the present second embodiment, descriptions of parts that are the same as in the first embodiment will be omitted, and only descriptions pertaining to the present second embodiment will be given.

First, when the user designates the user-designated region in the overhead image signal 109 from the overhead camera 102 via the control PC 107, that designated region is input into a detection region input unit 270 as a user-designated region 269. The detection region input unit 270 outputs the input user-designated region 269 to the color extraction unit 280 and the object detection unit 240 as a detection target region 271.

In the present second embodiment, the detection target region 271 is assumed to be selected as a rectangle, and the coordinates of the upper-left vertex and the coordinates of the lower-right vertex of the rectangular selected region are assumed to be expressed at the same resolution as the overhead image signal 109. Note that the detection target region 271 may output a trapezoidal shape, another polygonal shape, a free shape, or the like as well. Although the present second embodiment describes the detection target region as being selected by the user via the control PC 107, the control PC 107 may automatically select the region from the overhead image signal 109 from the overhead camera 102. For example, it is conceivable to apply edge processing to the overhead image signal 109 to detect lines indicating the field (court) of the sports competition, and for the control PC 107 to determine a detection target region that includes those lines.

Next, the color extraction unit 280 generates the color components of the pixels corresponding to the region of the reduced image signal 151 specified by the detection target region 271 as extracted color component information 281, and outputs that information to the motion component computation unit 230. The present embodiment assumes that the aforementioned color components are histograms of each of RGB components of the region corresponding to the detection target region 271 in the reduced image signal 151, which is expressed as the three components of R, G, and B. Note that the color components may be calculated through another method, and the histogram of each component may be obtained after converting the RGB components into a different color space, such as the HSV space. It is sufficient to express the characteristics of the color components within the relevant region of the detection target region 271 in any manner, such as using the respective average values of the RGB components within the relevant region of the detection target region 271.

Next, the motion component computation unit 230 generates the motion component enhanced image signal 231 based on the reduced image signal 151, the motion component image signal 221, and the extracted color component information 281, and outputs the generated signal to the object detection unit 240. At this time, the motion component computation unit 230 determines the color components to be computed for the reduced image signal 151 based on the extracted color component information 281. In the present embodiment, the motion component computation unit 230 generates the motion component enhanced image signal 231 by finding the mode values of the histograms of the three color components and applying computation processing to the color component having the lowest value, and then outputs the generated signal to the object detection unit 240. Like the first embodiment, the computation processing mentioned here is motion enhancement processing based on addition, but is not limited thereto. Any operations may be used as long as the motion component of the reduced image signal 151 can be enhanced; for example, the motion component computation unit 230 may scale all of the pixel values in the motion component image signal 221 to a minimum value of 1 and a maximum value of 2, and multiply that value by the reduced image signal 151 for each pixel.

Through the above processing, the motion component computation unit 230 can generate the motion component enhanced image signal 231 in which the saturation of the pixel values is suppressed and the contrast between the pixel values of a predetermined color component in the region in which there is motion and a region in which there is no motion is increased.

Then, the object detection unit 240 performs inference processing on the motion component enhanced image signal 231, and recognizes the coordinates and types of the players 20 and the ball 30. The detection result from the inference processing is rectangular coordinate values, as illustrated in FIG. 10. A plurality of player coordinate values are detected, as indicated in FIG. 10, and are output as multiple player coordinates 152 from the object detection unit 240. Note that if the object detection unit 240 detects a player 20 outside the region corresponding to the detection target region 271 input from the detection region input unit 270, object coordinates 241 from which that detection result is deleted are output to the shooting angle of view determination unit 250. This makes it possible to reduce false detections of players in the object coordinates 241, which may occur in spectator seats or the like.

Note that the details of the processing by the other blocks illustrated in FIG. 17 are the same as in the first embodiment, and will therefore not be described here.

As described above, when generating a video in which the motion component is enhanced from an image shot of the entire court, and detecting an object based on that video, the detection accuracy can be improved by obtaining a court region in which the players, the ball, or the like move in advance as a detection region.

Although the present embodiment describes the court region in the overhead image signal 109 as being designated via the control PC 107, and the color component information thereof as being obtained, the configuration can be such that one or more objects to be detected by the object detection unit 240 are selected. For example, if a region in which the basketball is present in the overhead image signal 109 is selected, the color extraction unit 280 can obtain the color component information of the basketball in the overhead image signal 109 in subsequent processing. Then, the motion component computation unit 230 can obtain the motion component enhanced image signal 231 in which the motion enhancement processing is applied only to the basketball by performing the motion component enhancement processing only on the pixel values having color component information close to the color component information of the basketball. Using the motion component enhanced image signal 231, the object detection unit 240 can detect the basketball in the overhead image signal 109 with greater accuracy.

Of the processing units described above, the object detection unit 240 executes processing using a model trained through machine learning, but rule-based processing using a lookup table (LUT), for example, may be performed instead. In this case, for example, relationships between input data and output data are generated in advance as an LUT. The generated LUT may then be stored in the memory of the image processing apparatus 103. When performing the processing of the object detection unit 240, the output data can be obtained by referring to the stored LUT. In other words, the LUT performs the processing of the processing unit by operating in cooperation with a CPU, a GPU, or the like as a program for performing the same processing as the processing unit.

### Third Embodiment

A third embodiment will describe a method for further improving the accuracy of the object detection even with a small amount of supervisory data by performing some data augmentation, which is applied to the supervisory data by the learning server 105, before the motion enhancement processing.

FIG. 18 is a flow of processing performed by the learning server 105 according to the third embodiment. The basic content of the descriptions is the same as in the first embodiment, and thus the present third embodiment will describe the learning server 105, which is a difference from the first embodiment.

First, in S730, the learning server 105 requests the supervisory data from the data collection server 106. Then, in S731, the learning server 105 waits to receive the supervisory data. If the supervisory data has been received, the learning server 105 controls the data storage unit 342 to store that data in the RAM 214, after which the sequence moves to S736.

Next, in S736, the learning server 105 controls the training data generation unit 343 to generate a color tone-changed image by performing color tone changing processing on the received data, and stores the generated image in the RAM 214. Here, the color tone changing processing may be a process for changing at least one of a hue, a saturation, and a brightness. Furthermore, the processing may be performed by changing at least one of the color components represented by a color space such as RGB or YUV. As these instances of changing unit, any of gain processing, offset processing, gamma processing, conversion processing using an LUT (Look Up Table), or the like may be used. After the training data generation unit 343 stores the color tone-changed image in the RAM 214, the learning server 105 moves the sequence to S732.

Next, in S732, the learning server 105 controls the training data generation unit 343 to generate a motion-enhanced image by performing the motion enhancement processing described above on the received data, and stores the generated image in the RAM 214. It is assumed that the same color tone changing processing is executed in S736 for a successive plurality of shot frames at predetermined time intervals used by the training data generation unit 343 in the motion enhancement processing. After the training data generation unit 343 stores the motion-enhanced image in the RAM 214, the learning server 105 moves the sequence to S737.

Next, in S737, the learning server 105 controls the training unit 344 to input the received data to the learning model. Here, the learning model is the learning network 403 mentioned earlier. After the training unit 344 inputs the supervisory data into the learning model, the learning server 105 moves the sequence to S738.

Next, in S738, the learning server 105 controls the training unit 344 to perform training using the learning network 403. After the training unit 344 performs the training of the learning network 403, the learning server 105 moves the sequence to S735.

Finally, in S735, the learning server 105 determines whether the input of all the supervisory data is complete, and when the input is determined to be complete, ends the learning processing.

Although the training data generation unit 343 performs the color tone changing processing on the received data in S736, the processing performed on the received data is not limited thereto. For example, noise adding processing that changes pixel values at random positions may be used. Denoising processing that removes noise may also be used. Sharpness enhancement processing using an unsharp mask method or the like may be used as well. Smoothing processing using a low-pass filter method or the like may be used as well. Furthermore, region replacement processing may be used. Here, “region replacement” refers processing for changing a partial region that matches a predetermined condition to another image for a target frame. For example, processing that replaces a region of specific pixel values in a given image, a region that has not changed from the previous frame, or the like with another image may be used. Alternatively, processing that separates a subject and a background image for a target image and changes a region of the background image to another image may be used. The color tone changing processing may also be replaced with a combination of a plurality of types of processing described above.

Additionally, in S737, the training unit 344 may input training setting values corresponding to the supervisory data to the learning model in the same manner as in the first embodiment, and in S738, the training unit 344 may perform data augmentation processing on the received data according to the training setting values. Here, the processing of data augmentation according to the training setting values may be executed as processing different from the color tone changing processing, noise addition, denoising processing, sharpness, smoothing, and region replacement described above, and shape transformation processing can be given as an example thereof. Here, “shape transformation processing” is processing that executes at least one of inversion, cropping, rotation, parallel movement, scaling, shearing, and projection conversion.

As described above, by implementing a part of the data augmentation applied to the supervisory data in a step prior to the motion enhancement processing, the supervisory data can be expanded without overwriting the result of the motion enhancement processing, which makes it possible to improve the detection accuracy.

According to the present invention, an object in a video can be detected at high speed and with high accuracy regardless of the size, motion, and the like thereof.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An image processing apparatus that detects a predetermined object in a video, the image processing apparatus comprising:
a reducing unit configured to generate a reduced image of a pre-set size from an image of a frame included in the video;
a generating unit configured to generate a motion component enhanced image based on a current reduced image expressing a current frame obtained by the reducing unit, a first reduced image from a predetermined length of time before the current reduced image, and a second reduced image from a predetermined length of time before the first reduced image; and
a determining unit configured to determine a position of an object using the motion component enhanced image obtained by the generating unit.

2. The image processing apparatus according to claim 1, wherein the video is a video overlooking a field for a sports competition.

3. The image processing apparatus according to claim 1, further comprising:
a trimming unit configured to extract, from a frame included in the video, a region containing positions of each of objects determined by the determining unit.

4. The image processing apparatus according to claim 1, wherein the determining unit determines the position of the object in the motion component enhanced image generated by the generating unit using learned data generated based on supervisory data including a motion component enhanced image and information indicating positions of each of objects in the motion component enhanced image.

5. The image processing apparatus according to claim 1, wherein the generating unit:
generates a first differential image indicating a difference between the current reduced image and the first reduced image;
generates a second differential image from a difference between the first reduced image and the second reduced image;
generates a third differential image obtained as a logical product of the first differential image and the second differential image;
generates a motion component image by subtracting the third differential image from the first differential image; and
generates the motion component enhanced image by adding the motion component image to the current reduced image.

6. The image processing apparatus according to claim 5, further comprising:
a region input unit configured to input a region of the video from which to detect an object; and
an extracting unit configured to extract a color of the object in the region input by the region input unit,
wherein the generating unit generates the motion component enhanced image further using the color extracted by the extracting unit.

7. A control method for an image processing apparatus that detects a predetermined object in a video, the control method comprising:
generating a reduced image of a pre-set size from an image of a frame included in the video;
generating a motion component enhanced image based on a current reduced image expressing a current frame obtained by the generating a reduced image, a first reduced image from a predetermined length of time before the current reduced image, and a second reduced image from a predetermined length of time before the first reduced image; and
determining a position of an object using the motion component enhanced image.

8. A non-transitory computer-readable storage medium which stores a program for causing a computer to execute a control method for an image processing apparatus that detects a predetermined object in a video, the control method comprising:
generating a reduced image of a pre-set size from an image of a frame included in the video;
generating a motion component enhanced image based on a current reduced image expressing a current frame obtained by the generating a reduced image, a first reduced image from a predetermined length of time before the current reduced image, and a second reduced image from a predetermined length of time before the first reduced image; and
determining a position of an object using the motion component enhanced image.

9. A system comprising a camera that shoots a video overlooking a field for a sports competition and an image processing apparatus that performs image processing for extracting a region for output from the video obtained by the camera,
wherein the image processing apparatus includes:
a reducing unit configured to generate a reduced image of a pre-set size from an image of a frame included in the video received from the camera;
a generating unit configured to generate a motion component enhanced image based on a current reduced image expressing a current frame obtained by the reducing unit, a first reduced image from a predetermined length of time before the current reduced image, and a second reduced image from a predetermined length of time before the first reduced image;
a determining unit configured to determine a position of an object using the motion component enhanced image obtained by the generating unit; and
a trimming unit configured to determine and trimming a region to be cut out from the video based on the position of the object determined by the determining unit.

10. A learned data generation method for generating learned data to be input to a learning model based on supervisory data, the learned data generation method comprising:
changing a color tone of a frame image included in the supervisory data and generating a color tone-changed image; and
generating a motion component enhanced image based on a current changed image expressing a current frame obtained in the changing, a first frame image from a predetermined length of time before the current changed image, and a second frame image from a predetermined length of time before the first frame image,
wherein the changing is performed prior to the generating.

11. A learned data generation method for generating learned data to be input to a learning model based on supervisory data, the learned data generation method comprising:
adding noise to a frame image included in the supervisory data and generating a noise-added image; and
of generating a motion component enhanced image based on a current added image expressing a current frame obtained in the adding, a first frame image from a predetermined length of time before the current added image, and a second frame image from a predetermined length of time before the first frame image,
wherein the adding is performed prior to the generating.

12. A learned data generation method for generating learned data to be input to a learning model based on supervisory data, the learned data generation method comprising:
removing noise of a frame image included in the supervisory data and generating a noise-removed image; and
generating a motion component enhanced image based on a current removed image expressing a current frame obtained in the removing, a first frame image from a predetermined length of time before the current removed image, and a second frame image from a predetermined length of time before the first frame image,
wherein the removing is performed prior to the generating.

13. A learned data generation method for generating learned data to be input to a learning model based on supervisory data, the learned data generation method comprising:
performing sharpness processing on a frame image included in the supervisory data and generating a sharpness image; and
generating a motion component enhanced image based on a current expanded image expressing a current frame obtained in the performing sharpness processing, a first frame image from a predetermined length of time before the current expanded image, and a second frame image from a predetermined length of time before the first frame image,
wherein the performing sharpness processing is performed prior to the generating.

14. A learned data generation method for generating learned data to be input to a learning model based on supervisory data, the learned data generation method comprising:
performing smoothing processing on a frame image included in the supervisory data and generating a smoothed image; and
generating a motion component enhanced image based on a current expanded image expressing a current frame obtained in the performing smoothing processing, a first frame image from a predetermined length of time before the current expanded image, and a second frame image from a predetermined length of time before the first frame image,
wherein the performing smoothing processing is performed prior to the generating.

15. A learned data generation method for generating learned data to be input to a learning model based on supervisory data, the learned data generation method comprising:
replacing a partial region of a frame image included in the supervisory data with an image different from the frame image and generating a region-replaced image; and
generating a motion component enhanced image based on a current replaced image expressing a current frame obtained in the replacing, a first frame image from a predetermined length of time before the current replaced image, and a second frame image from a predetermined length of time before the first frame image,
wherein the replacing is performed prior to the generating.

16. A learned data generation method for generating learned data to be input to a learning model based on supervisory data, the learned data generation method comprising:
generating a motion component enhanced image based on a current frame image expressing a current frame obtained from a frame image included in the supervisory data, a first frame image from a predetermined length of time before the current frame image, and a second frame image from a predetermined length of time before the first frame image; and
transforming a shape of the motion component enhanced image and generating a shape-transformed image,
wherein the transforming is performed after the generating.
